(19) United States
(12) Patent Application Publication
(10) Pub. No.: US 2012/0038836 A1
(43) Pub. Date: Feb. 16, 2012

(54) Echo light complex

(76) Inventor: Babak Taherloo, Copenhagen NV (DK)

(21) Appl. No.: 12/805,662

(22) Filed: Aug. 12, 2010

(51) Int. Cl. H04N 9/31; H04N 5/64; G06F 15/16

(52) U.S. Cl. 348/789; 709/219; 348/744; 348/E09.025; 348/E05.128

(57) ABSTRACT

The invention Echo Light Complex relates to broadcasting media content to passengers, of vessels or tools for transport. The term vessel will throughout this document and henceforth, be used as a general term for any tool, machine, vehicle, train, vessel, ship, aircraft, and any utility used for transport, whether it be on ground, on water or in air, whether it be with passengers or without. The invention Echo Light Complex broadcast media content to passengers of vessels by displaying visual media content on the surroundings of the tool for transport or vessel, with the help of projectors so that it can be viewed from inside the transport tool by the passengers. Meanwhile an audio signal is wirelessly transmitted, to enable the passengers to receive the audio content associated with the visual media being displayed. Units and components of the invention which is to be placed outside the vessel, will be protected by a cabinet, which allows the electronic and electrical components to work outside in the open air. The invention has many features which allows the passengers, transport tool operators, and the broadcasters of the media to have most possible usability and functionality regarding the use, update, maintenance and personalization of the invention for the benefit and best use of them all.

### FIELD OF THE INVENTION

The present invention relates generally to giving passengers in a vessel like trains or underground trains, a possibility to view and hear, media content, displayed on the wall or other items surrounding the vessel, and receiving the audio as a wireless signal, with personal devices, such as FM receivers.

The term vessel will throughout this document and henceforth, be used as a general term for any tool, machine, vehicle, train, vessel, ship, aircraft, and any utility used for transport, whether it be on ground, on water or in air, whether it be with passengers or without.

### BACKGROUND OF THE INVENTION

The invention will be described with the reference to a moving vessel, with a projector mounted on the vessel, either on the outside or from the inside, displaying visual media content by projecting on the surroundings of the vessel, while the sound associated with the media being displayed, will be broadcasted wirelessly to users of the vessel, who can receive the sound be using wireless receivers.

It is desirable for passenger when being transported in a vessel, Ex. a transport vessel, an underground train, a ship, to view media content, on the wall or surroundings of the vessel. Many features of this invention allows the passengers, operators of vessel and media broadcasters to have an easy and user friendly access and use of the invention and its functionality.

Although projectors are in use today, they have not been in use for displaying media content on the wall or surroundings of a moving vessel, like a train passing through a tunnel. The walls which so far could not be used for media content, such as promotional, informational or marketing purposes. This is because of the difficulties to put up or maintain almost any form of advertisement or media inside these tunnels, without delaying the traffic, or other difficulties connected with this form of advertisement. With Echo Light Complex it will now be possible and much more handy. It is here important to mention that Echo Light Complex uses the existing surroundings of the vessel as the area of which it will project upon, which makes the invention and its operating range, opportunities much wider, and allows it to function in most fields of transport known today.

The idea and effort of this invention is to broadcast media, advertise, or give information to users or passengers of a vessel, and at the same time to minimize the delay and maintenance cost involved with these kind of project.

### SUMMARY OF INVENTION

The present invention provides a projector which is mounted on a vessel, displaying media content on the surroundings of the vessel, and transmitting a wireless audio signal to the passengers or users of the vessel. The wireless audio signal may be transmitted by short distance FM or other available wireless transmitters. This wireless signal can then be received by the users of the vessel, using their wireless receivers, as an example they can use the FM-Radio on their cell phone.

It is worthy to mention that many steps have been taken to ensure that this system is an up to date, secure and well functioning system, allowing the passengers, vessel operators and media broadcasters to have as much control and personal preference choices as possible, without bargaining with their access, use and usability of the system.

### BRIEF DESCRIPTION OF THE DRAWINGS

FIG. 1 is an example of the projectors mounted on a train displaying the side view of projectors mounted above the windows of the train, displaying visual media content on the surroundings of the train, allowing passengers to view this from the inside of the train.

FIG. 2 is an example of the projectors displaying its visual content on the surroundings of the train. Here the train is being shown from a front view perspective.

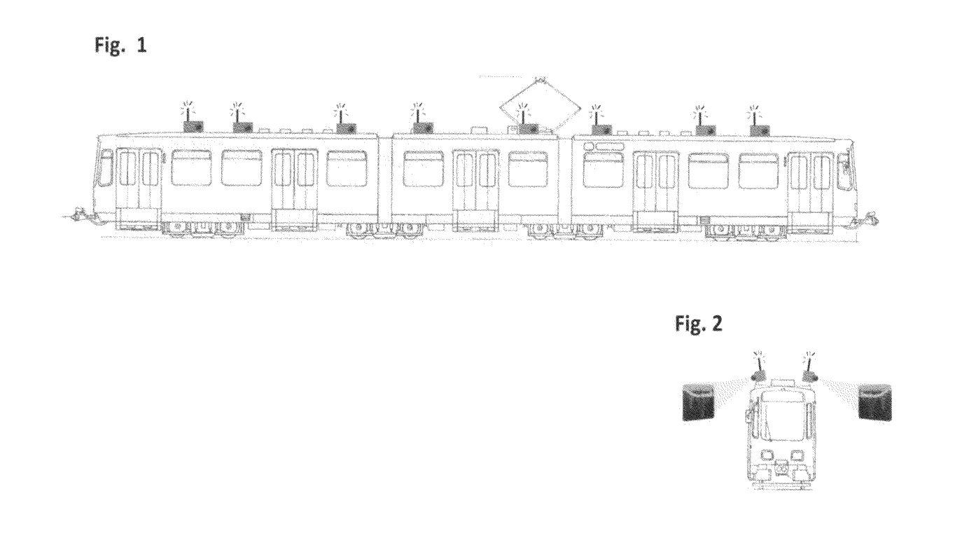

### DETAILED DESCRIPTION

### Projector

A projector mounted on a vessel where as the term vessel throughout this document and henceforth will be used as a general term for any tool, machine, vehicle, train, vessel, ship, aircraft, and any utility used for transport, whether it be on ground, on water or in air, whether it be with passengers or without. A projector mounted on a vessel displaying visual media content on the surroundings of the vessel. The Projectors mounted on the vessels, can display in all angles (X,Y,Z) and, and can be adjusted to display in the preferred angle that is possible or preferred by the vessel users.

Multiple projectors can be used for same projection, having the primary function of allowing one projector to switch off, and another to turn on projecting in the same place, so that the projectors are not overheated or start malfunctioning because of to continuously use.

The projectors can be switched off and on from the lamp, rather then shutting the whole projector down, enabling them to start and stop fast and without shutting the whole projector off or on.

### Local Server

These projectors are connected with a Local Server, which is aboard the vessel, containing the visual and audio media which is to be transmitted.

A Local Server will perform the task and function, of containing the Data, such as visual media, audio media, maintenance reports, bug reports, RSS Feeds, and other update needed. The local server will use cable or wireless connections to transfer and receive data, to the projectors, audio devices, sensors and other necessary electric devices. The Local server works together with a Central Server who will send and receive relevant Data such as the above mentioned examples, and which allows the Local servers to be controlled from one place.

### Wireless Audio

An wireless audio unit will receive the audio signal from the Local Server, and transmit this to the passengers wirelessly, using the wireless technology Ex. Bluetooth, or FM or other wireless technologies, which is used by passengers, and which is available on their personal devices, Ex. cell phones, and FM receivers, allowing them to receive the audio associated with the visual media being displayed.

### Cabinet

A cabinet can be used to protect and use the projectors, servers, sensors and other electronic and electrical components and devices in the open air with best possible results. This is done to guard these electronically and electric components and devices against conditions such as wind, rain, snow, heat, warm weather, cold weather, steam, dust and small air particles, oil particles, vandalism, theft etc., which in best case will decrease the quality of the systems performance and worst case cause the system to malfunction.

These cabinets will function as a general protector of the electrical and electronic components and units that needs to be placed outside the vessel. If needed these cabinets can be modified to include a cooling system, such as a refrigerator or cooling elements to keep the components inside the cabinet cold, in order to achieve best functionality and avoid malfunctions of those components. These cabinets can be modifies to include heating elements, in order to achieve best functionality and avoid malfunctions of those components. A thermostat within the cabinet can be used to control these heating or cooling mechanisms inside the cabinet. These thermostats can be adjusted manually, automatically or depending on the server model, from the central or local server by an operator.

These cabinets are constructed of various materials and in different shapes and sizes, based on the needs of the individual vessel and its geographical surroundings.

### Surroundings as Screen

The entire invention will function without the use of screens for the visual projections. Instead the projections from the projectors will be projected to existing facilities around the vessel, or existing surroundings of the vessel. No measures will be taken to place any screens, since this is complicated, expensive, most often dangerous, and in many cases unrealistic to implement.

The displayed projections will as mentioned be projected on the existing surrounds, natural for the vessel, and because of the vessel moving it will even the sometimes uneven natural surfaces of the surroundings.

### Central Server

The Central Server works as a communicator, that wirelessly or in some cases with wire, transfers and receives data from the Local Server. Its main task is to transfer media which is to be broadcasted from the Local Server aboard the vessel. It will also receive Data for maintainer related issues from the Local Server. Ex. if a connect is lost between the Local Server and a Projector.

### On/Off Sensors

These on/off sensors primary purpose will be to switch the projectors or the projector lamps off or on based on needs. Ex. if projectors are mounted on a vessel, and reaches a station, it is required for the projectors to turn off, for the reason of not projecting directly into the eyes of passengers, and then turn on again when the train vessel have left the station. The On/Off Sensors can be placed on the route of the vessel, the vessel itself, or onboard other vessels to shut down when vessels are passing. The On/Off sensors can be of different types of sensors, based on actual needs, Ex. motion detecting sensors, Light detecting sensors, light reflecting sensors etc.

### Tags

Tags can be placed along the route of the vessel, communicating with the Local Server aboard the vessel or the Central Server, and based on the geographical placement of the Tags it will broadcast appropriate media for that geographical area. The tags are based on sensors which will be placed along the track or route of the vessel and the vessel itself, and will recognize the vessels movement and current location on the track or route, and communicate this to the Local or Central Server in order for these servers to adapt and modify the media being displayed. The Tags can be sensors of different types, based on actual needs, Ex. motion detecting sensors, Light detecting sensors, light reflecting sensors.

### Time Specific Media

The local servers or the central server, if directly connected to the media units, can broadcast time specific content, which is based on the specific time, that the media is being broadcasted.

Wireless Connections, Direct Central Server and Direct Central Server to Multiple Local on Same Vessel & Direct Central Server to Multiple Local on Same Vessel with Unique Receiver ID's

The most easy and currently cost efficient way to decrease the amount of data and data lines, which is to be transferred wirelessly from the Central server to the Local server aboard the vessel, would preferably be to have the connection between the Central Server and the media units pass threw a local server which distributes the signals further to the media units such as projectors, wireless audio units and other units that must send or receive data in order for the system to function well.

Another way of sending and receiving the data would be the Direct Central server model.

The Direct Central Server Model, allows the central server to directly Send/receive data to a distributor which then distributes that data between all the media units aboard the vessel and the Central Server.

Further more the Direct Central Server model can be modified to include a unique ID, and using a single line connection for each vessel and the distributor on that vessel, with the difference that it will allow the distributor to sends unique data to each media units based on the unique ID of that specific Media Unit.

In the speed and with attention to the developing wireless internet connections, it is possible to make a direct connection to each media unit based on the multiple connection line for data allowing the media units to Send/Receive data from the central server independently.

### Manual Update of Local Server

Another way to update the servers aboard the vessel is the manual update model. The local servers will here be manually updated by authorized personal from the local servers aboard the vessels.

They can also download informational data regarding the media units manually, such as playlet statistics, maintenance status, etc.

External. Network

The Extended Network solution can be preferable when vessels are moving threw areas, or under conditions where a connection between a central server and a local server is poor, expensive or non existing. The extended will where connection to the central server is available will update data necessary on the local servers aboard the vessel and continue its travel. When again within the range of the connection of the central server it will again update. This can either be triggered automatically when the vessel is within range of the central server connection, or be preprogrammed to update within certain areas, to certain networks.

### GPS and Track Length Measuring Mechanisms

In some areas where the Echo Light Complex is to be used, it can be difficult to use tags, and On/Off Sensors, and in such cases an Gps or a Track Length measuring mechanism system can be preferable or necessary for the invention to function.

GPS measuring mechanism can be used to indicate the vessel current location, and based on preset coordinates communicate to the local or central servers to turn media units on or off, or to play media content according to the position and GPS coordinates of the vessel.

Likewise the Track Length measuring mechanism, will in some places without GPS connection, but a constant and fixed track/route which is not altered, be able to turn media units On and off, or play media content according to the measuring of the total length of the track compared to the distance the vessel have moved on the track so far.

### ID

The ID unit, is a unit which users of vessel ex. passengers can use, and which allows them to connect to the media being broadcasted. The user can when entering the vessel, give the local or central server information of the seat it will use, and receive media, audio as visual media, based on the users preferences.

Such preferences can be which seat or projector the user wants to view content on, start and end destination, time on vessel. Based on a prefixed user preference, the media which is displayed can then be adjusted to fit the preference of the user, in the users time aboard the vessel. Users can also change their prefixed preferences by updating their personal prefixed preferences on the local server, whether it be a temporarily or a permanent change.

Users can either choose to manually connect to the central or local server when entering the vessel, or auto connect, or both based on the personal prefixed preferences.

The users will be able to use their personal electric devices, such as ex. Cell Phones, PC, smart phones etc., to connect to the central or local servers in order to use the ID functionality to get media based on their personal preferences.

The connection between the user and their personal electronic devices and the central or local server for ID functionality, will be established with their personal electric devices, which allows the central or local server to broadcast media with the users personal preferences, on the location where the user is located, which is identified by either user input or automatically.

The users can add, update and change their personal preferences, from their personal account from the internet or using their personal devices.

### ID Even

ID even is a system allowing multiple users to share the projector, or visual media being displayed based and various variable, ex. their preferences, travel time, start and end destination.

The central or local server will then based on these variable show media content which is fairly shared between the users. It will as an example based on how many users who choose to use the same media broadcaster, how long time they will travel and their personal preferences, display media content adjusted hereto.

What is claimed is:

1. Apparatus mounted on a vessel, by vessel henceforth and throughout the document meaning any tool, machine, vehicle, train, vessel, ship, utility used for transport, displaying visual media on surroundings of the vessel, and transmitting a audio signal, associated with the media being displayed and can be updated by a server comprising:
Projector
A projector mounted inside or on the vessel displaying visual media content on the outside surroundings of the vessel. The Projectors mounted on the vessels, can display in all angles (X,Y,Z) and can be adjusted to display in the preferred angle that is possible or preferred by the vessel users.
Multiple projectors can be used for same projection, having the primary function of allowing one projector to switch off, and another to turn on projecting, in the same place, so that the projectors are not overheated or start malfunctioning because of to continuously use.
The projectors can be switched off and on from the lamp, rather then shutting the whole projector down, enabling them to start and stop fast and without shutting the whole projector off or on.
These projectors are connected with a Local Server, which is aboard the vessel, containing the visual and audio media which is to be transmitted.
Local Server
A Local Server will perform the task and function, of containing the Data, such as visual media, audio media, maintenance reports, bug reports, RSS Feeds, and other update and data needed. The local server will use cable or wireless connections to transfer and receive data, to the projectors, audio devices, sensors and other necessary electric devices. The Local server works together with a Central Server who will send and receive relevant Data such as the above mentioned examples, and which allows the Local servers to be controlled from one place.
surroundings as screens
The entire invention will function without the use of screens for the visual projections of the projectors. Instead the projections from the projectors will be projected to existing facilities or surroundings of the vessel.
Wireless Audio
An audio unit will transmit the audio signal from the Local Server, wirelessly to the passengers, using the wireless technology which is used by most passengers on their personal electric devices such as cell phones, allowing them to receive the audio associated with the visual media being displayed.
Central Server
The Central Server works as a communicator, that transfers and receives data from the Local Server. Its main task is to transfer media which is to be broadcasted from the Local Server aboard the vessel. It will also receive Data for maintenance related issues from the Local Server.
Tags
Tags can be placed along the route of the vessel, communicating with the Local Server aboard the vessel or the Central Server, and based on the geographical placement of the Tags along the route of the vessel, it will broadcast appropriate media for that geographical area.
The tags are based on sensors which will be placed along the track or route of the vessel and the vessel itself, and will register the vessels movement and current location on the track or route, and communicate this to the Local or Central Server in order for these servers to adapt and modify the media being displayed. The Tags can be sensors of different types, based on actual needs, Ex. motion detecting sensors, Light detecting sensors, light reflecting sensors.
Sensor—On/Off
These on/off sensors primary purpose will be to switch the projectors or the projector lamps off or on based on needs, or communicate to the central server, local server or projectors, to switch the projectors on or off. The On/Off Sensors can be placed on the route of the vessel, the vessel itself, or onboard other vessels to shut down projectors or other equipment when vessels are passing these sensors. The On/Off sensors can be of different types of sensors, based on actual needs, Ex. mechanical or light based sensors motion detecting sensors, light detecting sensors, light reflecting sensors, switches.
Time Specific
The local servers or the central server, if directly connected to the media units, can broadcast time specific content, which is based on the specific time, that the media is being broadcasted.

2. Apparatus of claim 1 with GPS instead of Playlist, or On/Off sensor, or On/Off Sensor and Playlist.
GPS measuring mechanism can be used to indicate the vessel current location, and based on preset coordinates communicate to the local or central servers to turn media units on or off, or to play media content according to the position and GPS coordinates of the vessel.

3. Apparatus of claim 1 with Track Length instead of Playlist, or On/Off sensor, or On/Off Sensor and Playlist, or GPS.
The Track Length measuring mechanism, will in places without GPS connection, but a constant and fixed track/route, be able to turn media units On and off, or play media content according to the measuring of the total length of the track compared to the distance the vessel have moved on the track so far.

4. Apparatus of claim 1, 2 and 3 with ID.
The ID unit, is a unit which users of vessel ex. passengers can use, and which allows them to connect to the media being broadcasted. The user can when entering the vessel, give the local or central server information of the seat it will use, and receive media, audio as visual media, based on the users preferences.

5. Apparatus of claim 1, 2 and 3 with ID Even.
ID even is a system allowing multiple users to share the projector, or visual media being displayed based and various variable, ex. their preferences, travel time, start and end destination.
The central or local server will then based on these variable show media content which is fairly shared between the users.

6. Apparatus of claim 1, 2 and 3 with manual update of local server.
Another way to update the servers aboard the vessel is the manual update model. The local servers will here be manually updated by authorized personal from the local servers aboard the vessels.
The authorized personal can download informational data regarding the media units manually, such as playlist statistics, maintenance status and other important information as well.

7. Apparatus of claim 1-5 with Direct Central Server.
The Direct Central Server Model, allows the central server to directly Send/receive data to a distributor which then distributes that data between all the media units aboard the vessel and the Central Server.
The data content is to be transferred/received wirelessly from the Central server to a distributor which further transfer/receives this Data to and from the media units such as projectors, wireless audio units and other units.

8. Apparatus of claim 7 with Direct Central Server to multiple local Servers on same vessel Another way of sending and receiving the data would be the Direct Central server model but in this way the Central Server will send and receive data to a single distributor, which then distributes the data to all the local servers aboard the vessels.

9. Apparatus of claim 7 and 8 with Direct Central Server to multiple local on same vessel with unique receiver ID's
Direct Central Server model can be modified to include a unique ID, thereby allowing the use of a single Data line connection for each vessel that contains a Unique ID, so that the distributor on that vessel, can sends and Receive unique data to and from the central server to each media units based on the unique ID of that specific Media Unit.

10. Apparatus of claim 1-9 with a cabinet to be used to protect and enable the use of and ensure the best possible results with the use of the projectors, servers, sensors and other electronic and electrical components and devices, guarding these electronic and electric components and devices against conditions such as wind, rain, snow, heat, warm weather, cold weather, steam, dust and small air particles, oil particles, vandalism, theft etc., in the open air outside the vessel, which without this cabinet in best case will decrease the quality of the systems performance and worst case cause the system to malfunction.
If needed these cabinets can be modified to include a cooling system, such as a refrigerator or cooling elements to keep the components inside the cabinet cold, in order to achieve best functionality and avoid malfunctions of those components. These cabinets can be modifies to include heating elements, in order to achieve best functionality and avoid malfunctions of those components.
A thermostat within the cabinet can be used to control these heating or cooling mechanisms inside the cabinet. These thermostats can be adjusted manually, automatically or depending on the server model, from the central or local server by an operator.
These cabinets are constructed of various materials and in different shapes and sizes, based on the needs of the individual vessel and its geographical surroundings.
